(19) United States
(12) Patent Application Publication
(10) Pub. No.: US 2011/0074340 A1
(43) Pub. Date: Mar. 31, 2011

(54) Portable electronic device charging module with changeable plug connector

(76) Inventor: Golden-City Kao, Banqiao City (TW)

(21) Appl. No.: 12/591,078

(22) Filed: Nov. 6, 2009

(30) Foreign Application Priority Data
Sep. 29, 2009 (TW) 98217939

(51) Int. Cl. H02J 7/00

(52) U.S. Cl. 320/107

(57) ABSTRACT

A portable electronic device charging module with changeable plug connector includes a charging module; a charging port connected to one end of the charging module for electrically connecting to an electronic device for conducting electric energy from the electronic device to the charging module, so that the electric energy is stored in the charging module; and a plug connector fitting seat connected to the other end of the charging module for at least one changeable plug connector to connect thereto. When the changeable plug connector is connected to the plug connector fitting seat by sliding in a sliding-fit direction defined by a pair of sliding-fit sections on the plug connector fitting seat, the charging module can supply power to or charge a mobile electronic product via the plug connector fitting seat and the changeable plug connector, to which the mobile electronic product is connected.

### FIELD OF THE INVENTION

The present invention relates to a charging module, and more particularly, to a portable electronic device charging module with changeable plug connector.

### BACKGROUND OF THE INVENTION

With the popularization of mobile electronic products, cellulous phones, personal digital assistants (PDAs), digital music players, etc. have become electronic devices being frequently carried about by people living in the modern society. In addition to enable mobile communication and data storage, these mobile electronic products also satisfy consumers' demands for entertainment. Most of these mobile electronic products have a built-in rechargeable battery. When the power of the rechargeable battery of the mobile electronic product is exhausted, the rechargeable battery can be recharged by connecting a power supply equipped with the mobile electronic product to an alternating current (AC) or a direct current (DC) outlet.

As suggested by its name, the mobile electronic product is frequently carried about by a user for use at different places. There are times the mobile electronic product has an exhausted rechargeable battery and no AC or DC outlet is available for charging or powering the mobile electronic product. Therefore, it is desirable to provide a portable electronic device charging module for powering a mobile electronic product or charging the battery thereof.

Conventionally, a power supply has a specific power input/output interface for powering or charging a corresponding mobile electronic product. Some of the conventional power supplies can be connected to a computer device via a universal serial bus (USB) interface, so as to supply AC voltage of 5V to the mobile electronic product to power or charge the same.

However, when a general mobile electronic product is connected to the computer device for exchanging data and at the same time utilizes the USB interface of the computer device to obtain AC voltage of 5V for powering or charging the mobile electronic product, the computer device must be turned on all the time until the mobile electronic product is fully charged, lest the charging should be interrupted due to shutdown of the computer device to result in incomplete charging of the mobile electronic product.

Further, the conventional power supply each can be used to power or charge only one type of mobile electronic product. In other words, the conventional power supply each has a hardware connecting interface that is adapted to only one type of mobile electronic product. When a user has several types of mobile electronic products that have different hardware connecting interfaces, the user has to purchase a portable power supply for each of the mobile electronic products. Under this condition, the user has to spend additional money and inconveniently carry all these portable power supplies about for use.

### SUMMARY OF THE INVENTION

It is therefore a primary object of the present invention to provide a portable electronic device charging module with changeable plug connector to overcome the drawbacks of the conventional power supply, so that a user can supply power to or charge different mobile electronic products with only one power supply.

The solution adopted in the present invention to overcome the problems of the conventional techniques comprises a portable electronic device charging module with changeable plug connector. The portable electronic device charging module with changeable plug connector includes a charging module which is provided with at least one rechargeable battery. A charging port is connected to one end of the charging module for electrically connecting to an electronic device for conducting electric energy from the electronic device to the charging module, so that the electric energy is stored in the rechargeable battery of the charging module.

A plug connector fitting seat is connected to the other end of the charging module for at least one changeable plug connector to connect thereto. The plug connector fitting seat includes a fitting end face, a pair of sliding-fit sections and at least one set of conducting contacts. The sliding-fit sections are correspondingly formed on the fitting end face at two opposite sides thereof to define a sliding-fit direction. The set of conducting contacts are arranged in the recess portion to space from each other.

When the changeable plug connector is connected to the plug connector fitting seat by sliding in a sliding-fit direction by the sliding-fit sections on the plug connector fitting seat, the conducting contacts on the plug connector fitting seat are correspondingly in contact with the conducting contacts on the raised portion of the changeable plug connector, and thereby the charging module can supply power to or charge a mobile electronic product via the plug connector fitting seat and the changeable plug connector, to which the mobile electronic product is connected.

The portable electronic device charging module with changeable plug connector according to the present invention includes at least one rechargeable battery, which can continuously supply normal voltage source to the mobile electronic product even when a computer device, to which the charging module is connected to obtain electric energy, is in a power low condition or in a shutdown state, so that the mobile electronic product can be continuously charged for normal operation.

With the present invention, different changeable plug connectors can be selectively connected to a plug connector fitting seat to adapt the charging module to different input interfaces of different mobile electronic products. The user needs only to select a plug connector corresponding to the input interface of the mobile electronic product to be charged and connect the plug connector to the plug connector fitting seat, and the charging module can supply power to or charge the mobile electronic product. Therefore, the user need not expend extra money to buy or troublesomely carry about a plurality of portable power supplies for different mobile electronic products.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an assembled perspective view of a portable electronic device charging module with changeable plug connector according to a first embodiment of the present invention;

FIG. 2 is an exploded view of FIG. 1;

FIG. 3A is a top view of a plug connector fitting seat for the first embodiment of the present invention;

FIG. 3B is a bottom view of a changeable plug connector for the first embodiment of the present invention;

FIG. 4 is a perspective view showing the manner of connecting the changeable plug connector to the plug connector fitting seat of the first embodiment of the present invention by sliding fit in a predetermined direction;

FIG. 5 is an assembled perspective view of a portable electronic device charging module with changeable plug connector according to a second embodiment of the present invention;

FIG. 6 is an assembled perspective view of a portable electronic device charging module with changeable plug connector according to a third embodiment of the present invention; and

FIG. 7 shows an example of using the present invention to charge a mobile electronic product.

### DETAILED DESCRIPTION OF THE PREFERRED EMBODIMENTS

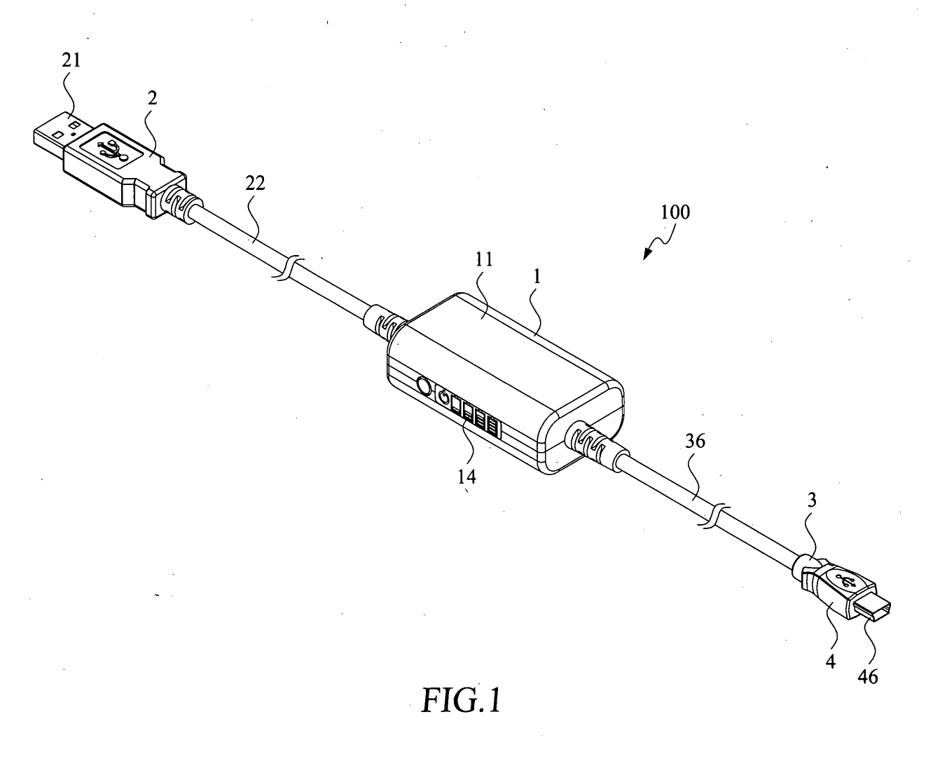

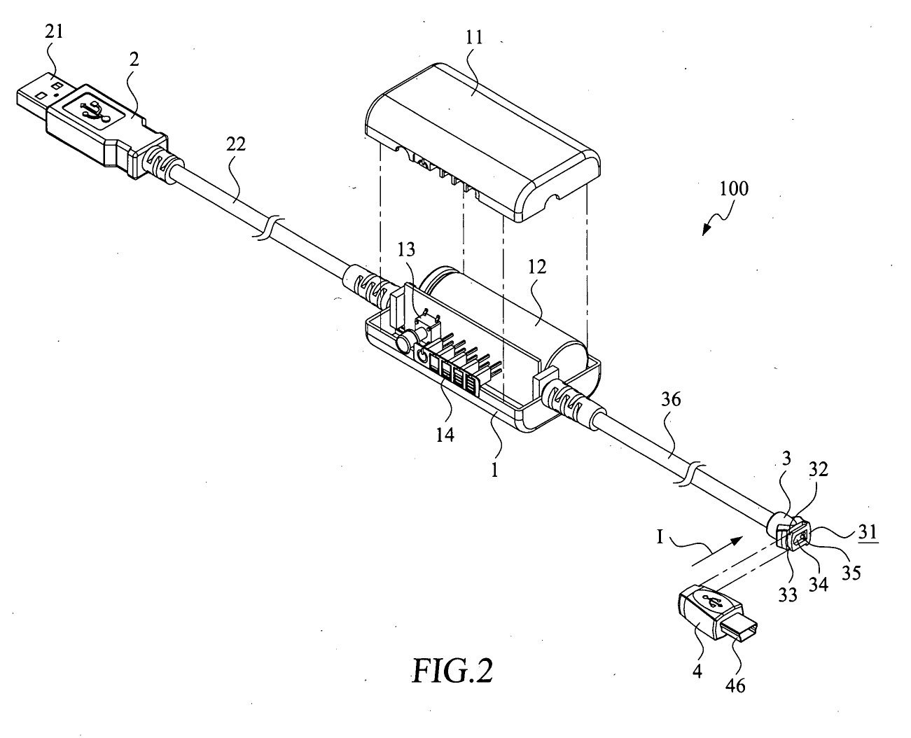

Please refer to FIGS. 1 and 2 that are assembled and exploded perspective views, respectively, of a portable electronic device charging module with changeable plug connector according to a first embodiment of the present invention. The first embodiment of the present invention is generally denoted by reference numeral 100, and includes a charging module 1 having a case 11, in which at least one rechargeable battery 12 is provided. The charging module 1 also includes a battery level detection unit 13 and a battery level indication unit 14. The battery level detection unit 13 is electrically connected to both of the rechargeable battery 12 and the batter level indication unit 14 for detecting a battery level of the rechargeable battery 12 and showing a detected result on the battery level indication unit 14, allowing a user to know from the battery level indication unit 14 the exact battery power of the rechargeable battery 12 available for use.

A charging port 2 is provided to one end of the charging module 1, and includes a USB plug connector 21 and an extension cable 22. The extension cable 22 is extended between and connected to the USB plug connector 21 and the charging module 1. The USB plug connector 21 of the charging port 2 can be electrically connected to an electronic device. As known by one of ordinary skill in the art, the USB plug connector 21 can be used not only as a medium for transferring message and data, but also to plug in a USB slot on an electronic device to obtain and accordingly supply an active voltage of 5V and a current of 0.5 A. In the illustrated embodiment of the present invention, with the charging port 2, electric energy can be conducted to and stored in the rechargeable battery 12 of the charging module 1 to serve as stored electric energy and power supply.

As shown in FIGS. 1 and 2, a plug connector fitting seat 3 is provided to the other end of the charging module 1 opposite to the charging port 2, and is connected to the charging module 1 via an extension cable 36. The plug connector fitting seat 3 is provided for at least one changeable plug connector 4 to connect thereto. The changeable plug connector 4 has an output interface 46 for plugging in a corresponding port on a mobile electronic product.

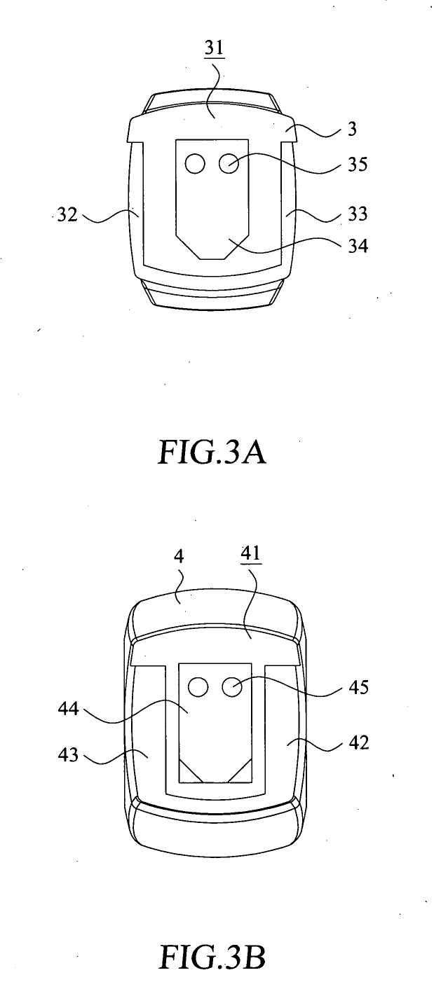

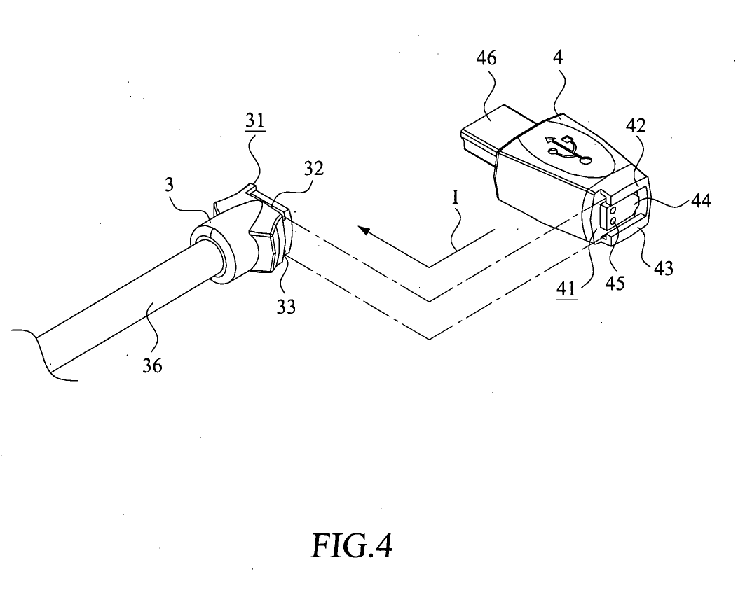

FIG. 3A is a top view of the plug connector fitting seat 3 for the first embodiment of the present invention; FIG. 3B is a bottom view of the changeable plug connector 4 for the first embodiment of the present invention; and FIG. 4 is a perspective view showing the manner of connecting the changeable plug connector 4 to the plug connector fitting seat 3 of the first embodiment of the present invention by sliding fit in a predetermined direction. Please refer to FIGS. 3A, 3B and 4 at the same time. The plug connector fitting seat 3 includes a fitting end face 31, a pair of sliding-fit sections 32, 33, and at least one set of conducting contacts 35. The fitting end face 31 of the plug connector fitting seat 3 is formed with a recess portion 34, and the set of conducting contacts 35 are arranged in the recess portion 34 to space from each other. The sliding-fit sections 32, 33 are correspondingly formed on the fitting end face 31 at two opposite sides thereof to define a sliding-fit direction I. In the illustrated first embodiment, the sliding-fit sections 32, 33 are a guide groove each.

The changeable plug connector 4 includes a fitting end face 41, a pair of retaining sections 42, 43 corresponding to the sliding-fit sections 32, 33 of the plug connector fitting seat 3, and a set of conducting contacts 45. The fitting end face 41 of the changeable plug connector 4 is formed with a raised portion 44 corresponding to the recess portion 34 on the plug connector fitting seat 3, and the set of conducting contacts 45 are arranged on the raised portion 44 to space from each other. In the illustrated first embodiment, the retaining sections 42, 43 are a guide rail each.

When the retaining sections 42, 43 of the changeable plug connector 4 are engaged with the sliding-fit sections 32, 33 of the plug connector fitting seat 3 by moving the changeable plug connector 4 in the sliding-fit direction I defined by the sliding-fit sections 32, 33, the changeable plug connector 4 is connected to the plug connector fitting seat 3 by sliding fit, and the conducting contacts 35 on the plug connector fitting seat 3 are correspondingly in contact with the conducting contacts 45 on the raised portion 44 of the changeable plug connector 4. With these arrangements, the charging module 1 and the rechargeable battery 12 thereof can supply electric power to the corresponding mobile electronic product via the plug connector fitting seat 3 and the output interface 46 of the changeable plug connector 4, which is connected to the plug connector fitting seat 3 by sliding fit. And, in the illustrated first embodiment, the changeable plug connector 4 is a USB plug connector. However, it is understood the USB plug connector is illustrated only as a preferred embodiment of the present invention, and the changeable plug connectors 4 in other embodiments can have different output interfaces.

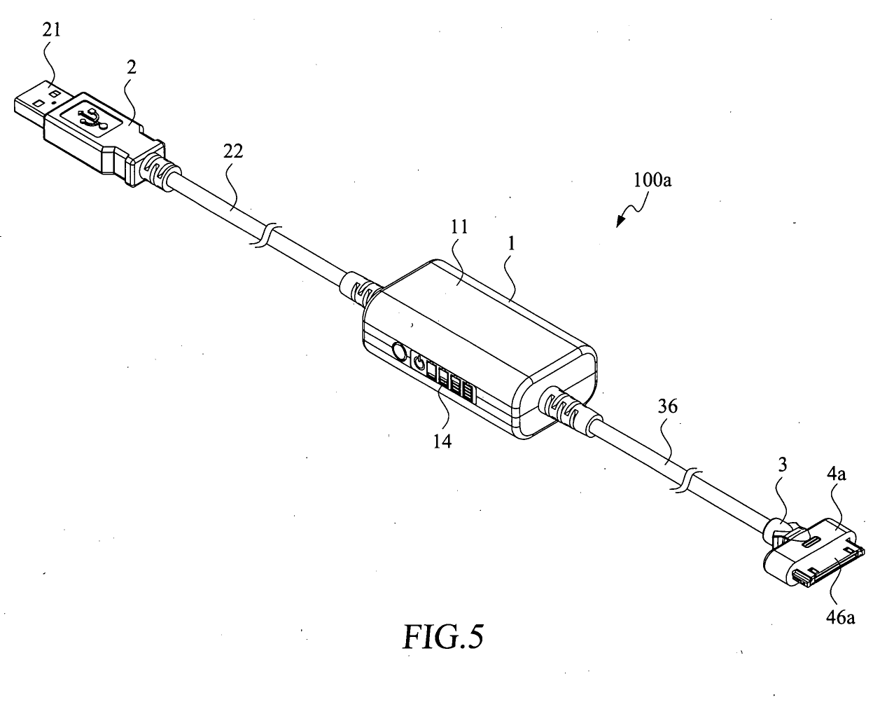

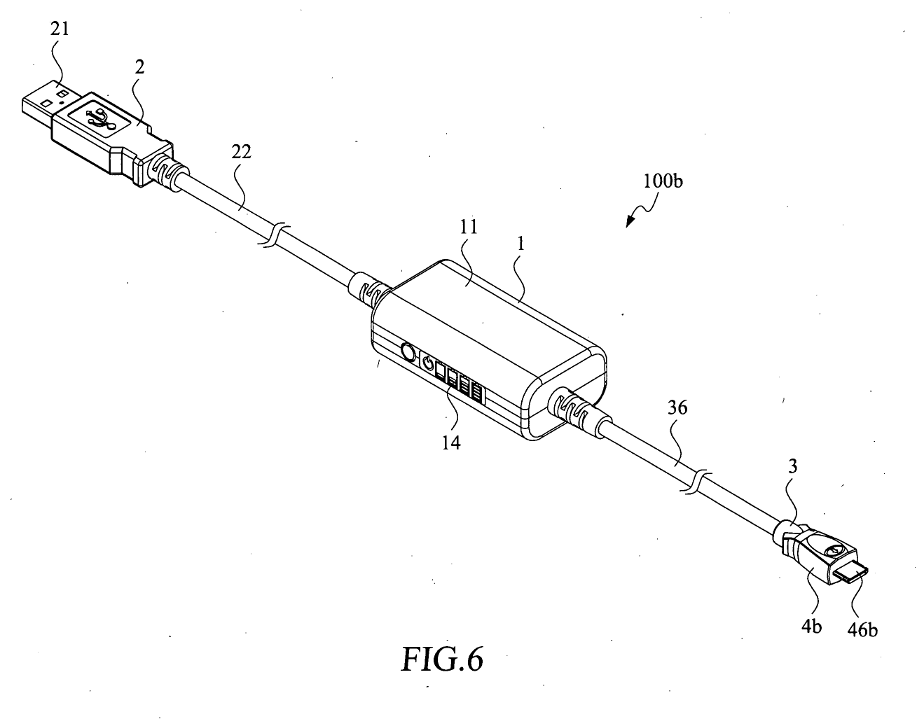

Please refer to FIGS. 5 and 6 that are assembled perspective views of portable electronic device charging modules with changeable plug connector according to a second and a third embodiment of the present invention, respectively, which are denoted by reference numerals 100a and 100b, respectively. As shown, the second and the third embodiment 100a, 100b are generally structurally similar to the first embodiment 100, except for changeable plug connectors 4a, 4b that have output interfaces 46a, 46b different from the output interface 46. Therefore, for the purpose of easy to understand, elements that are the same in the three embodiments are denoted by the same reference numerals.

As the changeable plug connector 4 in the first embodiment 100, the changeable plug connectors 4a, 4b are also connected to the plug connector fitting seat 3 in the manner of sliding fit by slidably engaging the retaining sections 42, 43 with the sliding-fit sections 32, 33. In the present invention, the second and the third embodiment 100a, 100b are adaptable to different mobile electronic products. Since different mobile electronic products might have different power input interfaces, the present invention uses plug connectors 4a, 4b of different output interfaces 46a, 46b for connecting to corresponding mobile electronic products.

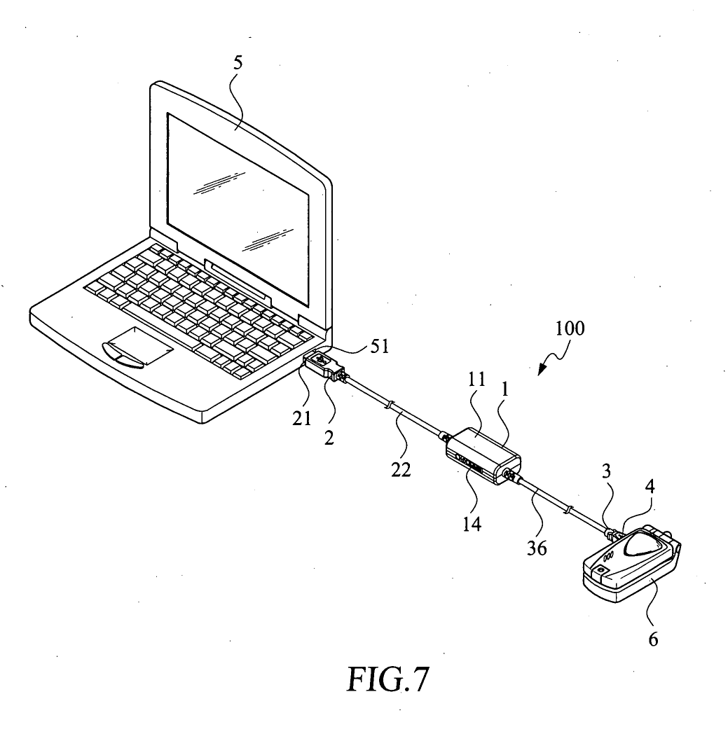

Please refer to FIG. 7 that shows an example of using the first embodiment 100 of the present invention to charge a mobile electronic product. As shown, the USB plug connector 21 of the charging port 2 is electrically connected to a USB slot 51 on an electronic device 5, which is a notebook computer in the illustrated example; and the changeable plug connector 4 is connected to a mobile electronic product 6, which is a mobile phone in the illustrated example. With the charging port 2, electric energy is conducted from the electronic device 5 to and stored in the rechargeable battery 12 of the charging module 1 to serve as stored electric energy, which can also be supplied to the mobile electronic product 6 to power or charge the latter.

When the electronic device 5 is in a battery low condition or in a shutdown state, the rechargeable battery 12 of the charging module 1 with electric energy stored therein can still supply a normal voltage source to the mobile electronic product 6 without being interrupted, allowing the mobile electronic product 6 to be charged or operate in a continuous and normal manner.

Further, in other examples of application, the present invention can be used to charge other different types of mobile electronic products simply by changing the changeable plug connector 4 to other ones having suitable output interfaces corresponding to the mobile electronic products 6 to be charged. Therefore, with the present invention, a user needs to buy only one portable electronic device charging module with changeable plug connector to supply power to different types of mobile electronic products or charge the batteries thereof.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A portable electronic device charging module, comprising a charging module provided with at least one rechargeable battery, a first end connected to a charging port for charging the charging module, a second end connected to a plug connector fitting seat for at least one changeable plug connector to connect thereto, the plug connector fitting seat including:
a fitting end face;
a pair of sliding-fit sections being correspondingly provided on the fitting end face at two opposite sides thereof to define a sliding-fit direction; and
at least a pair of conducting contacts being arranged on the fitting end face to space from each other;
whereby when the changeable plug connector is connected to the plug connector fitting seat by sliding the changeable plug connector in the sliding-fit direction to engage a pair of retaining sections on the changeable plug connector with the pair of sliding-fit sections on the plug connector fitting seat, the conducting contacts on the plug connector fitting seat are correspondingly in contact with two conducting contacts provided on a fitting end face of the changeable plug connector.

2. The portable electronic device charging module as claimed in claim 1, wherein the fitting end face of the plug connector fitting seat is provided with a recess portion, and the conducting contacts thereof are arranged in the recess portion; and wherein the fitting end face of the changeable plug connector is provided with a raised portion corresponding to the recess portion, and the conducting contacts of the changeable plug connector are arranged on the raised portion.

3. The portable electronic device charging module as claimed in claim 1, wherein the pair of sliding-fit sections include two guide grooves, and the pair of retaining sections on the changeable plug connector include two guide rails corresponding to the two guide grooves.

4. The portable electronic device charging module as claimed in claim 1, wherein the charging port connected to the charging module includes a USB plug connector and an extension cable extended between and connected to the USB plug connector and the charging module.

5. The portable electronic device charging module as claimed in claim 1, wherein the changeable plug connector includes a USB plug connector.

6. The portable electronic device charging module as claimed in claim 1, wherein the plug connector fitting seat is connected to the charging module via an extension cable.
